(19) United States
(12) Patent Application Publication
(10) Pub. No.: US 2026/0064410 A1
(43) Pub. Date: Mar. 5, 2026

(54) METHOD AND SYSTEM FOR AUTOMATING PEER CODE REVIEWS

(71) Applicant: JPMorgan Chase Bank, N.A., New York, NY (US)

(72) Inventors: Venkata Mohit TAMANAMPUDI, New Castle, DE (US); Ravi KURUGANTHY, Frisco, TX (US); Jayaprakash MOSES, Greenville, DE (US); Priya Darshini AMARA, Glen Mills, PA (US)

(73) Assignee: JPMorgan Chase Bank, N.A., New York, NY (US)

(21) Appl. No.: 18/938,981

(22) Filed: Nov. 6, 2024

Related U.S. Application Data
(60) Provisional application No. 63/690,933, filed on Sep. 5, 2024.

(51) Int. Cl. G06F 8/73

(52) U.S. Cl. CPC G06F 8/73

(57) ABSTRACT

A method and a system for automating a peer code review are provided. The method includes: receiving a pull request associated with an evaluation of a source code; generating, based on the pull request, a workflow associated with the evaluation of the source code; transmitting the workflow and the source code to a plurality of AI agents; performing, via the plurality of AI agents, a review of the source code, and each respective AI agent of the plurality of AI agents is responsible for a separate code review process from among a plurality of code review processes; aggregating each respective result from among the plurality of code review processes; and determining, based on the aggregating of each respective result, whether the pull request passes the evaluation of the source code.

### CROSS-REFERENCE TO RELATED APPLICATION

This application claims the benefit from U.S. Provisional Application No. 63/690,933, filed Sep. 5, 2024, which is hereby incorporated by reference in its entirety.

### BACKGROUND

### 1. Field of the Disclosure

This technology generally relates to methods and systems for automating peer code reviews, and more particularly to methods and systems for efficiently analyzing code to provide suggestions for peer reviewers when reviewing the code.

### 2. Background Information

Code reviews are a critical aspect of software development, ensuring code quality, adherence to standards, and overall system reliability. Traditional peer code reviews, however, can be time-consuming and prone to error. Current peer code review processes face issues with delayed feedback loops, inconsistent analysis and feedback, and system bias. Particularly, these issues stem from a lack of synchronization and integration among current peer review code systems and result in inefficient system resource usage issues due to the lack of consistency and integration among the systems.

Accordingly, there is a need for efficiently analyzing code to provide suggestions for peer reviewers when reviewing the code.

### SUMMARY

The present disclosure, through one or more of its various aspects, embodiments, and/or specific features or sub-components, provides, inter alia, various systems, servers, devices, methods, media, programs, and platforms for efficiently analyzing code to provide suggestions for peer reviewers when reviewing the code.

According to an aspect of the present disclosure, a method for automating a peer code review is provided. The method is implemented by at least one processor. The method includes: receiving, by the at least one processor, a pull request associated with an evaluation of a source code; generating, by the at least one processor and based on the pull request, a workflow associated with the evaluation of the source code; transmitting, by the at least one processor, the workflow and the source code to a plurality of AI agents; performing, by the at least one processor via the plurality of AI agents, a review of the source code, wherein each respective AI agent of the plurality of AI agents is responsible for a separate code review process from among a plurality of code review processes; aggregating, by the at least one processor, each respective result from among the plurality of code review processes; and determining, by the at least one processor and based on the aggregating of each respective result, whether the pull request passes the evaluation of the source code.

The method may further include coordinating, by the at least one processor via a Large Language Model (LLM), each of the plurality of the AI agents and providing context-aware processing for the performing of the review, wherein the LLM is trained on at least one from among a code framework and an engineer handbook in order to understand and generate responses in a context associated with a software development.

The method may further include: identifying, by the at least one processor via the LLM, at least one potential problem associated with the source code; and generating, by the at least one processor via the LLM, at least one proposed source code solution, based on the at least one from among the code framework and the engineer handbook, for remedying the at least one identified potential problem.

The method may further include generating, by the at least one processor via the LLM, at least one from among a first explanation that relates to an understanding of the code framework and a second explanation that relates to at least one engineering concept associated with the source code.

The plurality of code review processes may include at least one from among validating a pipeline configuration, testing an individual module of the source code, testing a contract of the source code, testing a component of the source code, testing acceptance of the source code, testing end-to-end results of the source code, testing a performance of the source code, testing resiliency of the source code, providing code review feedback of the source code, testing a compatibility of the source code, testing security vulnerabilities of the source code, and testing business functionality of the source code.

The method may further include: triggering, by the at least one processor via a developer platform, the generating of the workflow; and coordinating, by the at least one processor via the developer platform, the performing of the review by the plurality of AI agents.

The method may further include integrating, by the at least one processor, at least one source code analysis tool for testing the source code and for validating the evaluation of the source code.

Each of the plurality of code review processes may be executed in parallel among the plurality of AI agents.

The method may further include: generating, by the at least one processor, a report that includes the determination of whether the pull request passes the evaluation, an assessment of each respective result from among the plurality of code review processes, and an assessment of compliance of the source code with a predetermined standard; and transmitting, by the at least one processor, the report to a user associated with the pull request.

According to another aspect of the present disclosure, a computing apparatus for automating peer code reviews is provided. The computing apparatus includes a processor; a memory; and a communication interface coupled to each of the processor, and the memory. The processor is configured to: receive a pull request associated with an evaluation of a source code; generate, based on the pull request, a workflow associated with the evaluation of the source code; transmit the workflow and the source code to a plurality of AI agents; perform, via the plurality of AI agents, a review of the source code, wherein each respective AI agent of the plurality of AI agents is responsible for a separate code review process from among a plurality code review processes; aggregate each respective result from among the plurality of code review processes; and determine, based on the aggregating of each respective result, whether the pull request passes the evaluation of the source code.

The processor may be further configured to coordinate, via a Large Language Model (LLM), each of the plurality of the AI agents and providing context aware processing for the performing of the review, wherein the LLM is trained on at least one from among a code framework and an engineer handbook in order to understand and generate responses in a context associated with a software development.

The processor may be further configured to: identify, via the LLM, at least one potential problem associated with the source code; and generate, via the LLM, at least one proposed source code solution, based on the at least one from among the code framework and the engineer handbook, for remedying the at least one identified potential problem.

The processor may be further configured to generate, via the LLM, at least one from among a first explanation that relates to an understanding of the code framework and a second explanation that relates to at least one engineering concept associated with the source code.

The plurality of code review processes may include at least one from among validating a pipeline configuration, testing an individual module of the source code, testing a contract of the source code, testing a component of the source code, testing acceptance of the source code, testing end-to-end results of the source code, testing a performance of the source code, testing resiliency of the source code, providing code review feedback of the source code, testing a compatibility of the source code, testing security vulnerabilities of the source code, and testing business functionality of the source code.

The processor may be further configured to: trigger, via a developer platform, the generation of the workflow; and coordinate, via the developer platform, the performance of the review by the plurality of AI agents.

The processor may be further configured to integrate at least one source code analysis tool for testing the source code and to validate the evaluation of the source code.

Each of the plurality of code review processes may be executed in parallel among the plurality of AI agents.

The processor may be further configured to: generate a report that includes the determination of whether the pull request passes the evaluation, an assessment of each respective result from among the plurality of code review processes, and an assessment of compliance of the source code with a predetermined standard; and transmit the report to a user associated with the pull request.

According to yet another aspect of the present disclosure, a non-transitory computer readable storage medium storing instructions for automating peer code reviews is provided. The storage medium includes executable code which, when executed by a processor, causes the processor to: receive a pull request associated with an evaluation of a source code; generate, based on the pull request, a workflow associated with the evaluation of the source code; transmit the workflow and the source code to a plurality of AI agents; perform, via the plurality of AI agents, a review of the source code, wherein each respective AI agent of the plurality of AI agents is responsible for a separate code review process from among a plurality code review processes; aggregate each respective result from among the plurality of code review processes; and determine, based on the aggregating of each respective result, whether the pull request passes the evaluation of the source code.

The storage medium may be further configured to coordinate, via a Large Language Model (LLM), each of the plurality of the AI agents and providing context aware processing for the performing of the review, wherein the LLM is trained on at least one from among a code framework and an engineer handbook in order to understand and generate responses in a context associated with a software development.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for efficiently analyzing code to provide suggestions for peer reviewers when reviewing the code, according to an embodiment.

FIG. 2 illustrates a diagram of a network environment for efficiently analyzing code to provide suggestions for peer reviewers when reviewing the code, according to an embodiment.

FIG. 3 illustrates a system diagram of a system for efficiently analyzing code to provide suggestions for peer reviewers when reviewing the code, according to an embodiment.

FIG. 4 illustrates a process diagram of a process for efficiently analyzing code to provide suggestions for peer reviewers when reviewing the code, according to an embodiment.

FIG. 5 illustrates a system architectural diagram for efficiently analyzing code to provide suggestions for peer reviewers when reviewing the code, according to an embodiment.

FIG. 6A illustrates a flow diagram for efficiently analyzing code to provide suggestions for peer reviewers when reviewing the code, according to an embodiment.

FIG. 6B illustrates a flow diagram for efficiently analyzing code to provide suggestions for peer reviewers when reviewing the code, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein increases speed, efficiency, consistency, and accuracy for performing peer code reviews of written source code. Particularly, when new source code is written within an organization, the source code is reviewed by one or more peers prior to publishing or implementing the source code. For example, when a source code is ready to be reviewed, a pull request may be submitted so that at least one peer, coworker, or supervisor may review and test the source code. The system works by receiving the pull request and then analyzing the source code to generate a workflow for evaluating the source code. The system then coordinates a plurality of AI agents for performing a variety of code review processes, based on the generated workflow. Based on these review processes, the system may identify issues associated with the source code and provide recommendations for correcting them. The system may then also aggregate or combine the results from all the code review processes and determines whether the pull request, based on the source code review, passes the evaluation. This system enhances the code review process by ensuring consistent and thorough analysis of code changes, leading to higher code quality and fewer bugs. The system may also employ parallel execution of AI agents to significantly reduce the time required for code reviews, enabling faster development cycles and quicker deployment of new features. Additionally, this system may be integrated with various tools to ensure that all aspects of the code are tested, from unit and acceptance testing to performance and security analysis. Thus, this system improves synchronization and efficiency of system resource usage issues by coordinating AI agents in a standardized and synchronized way for performing source code evaluations.

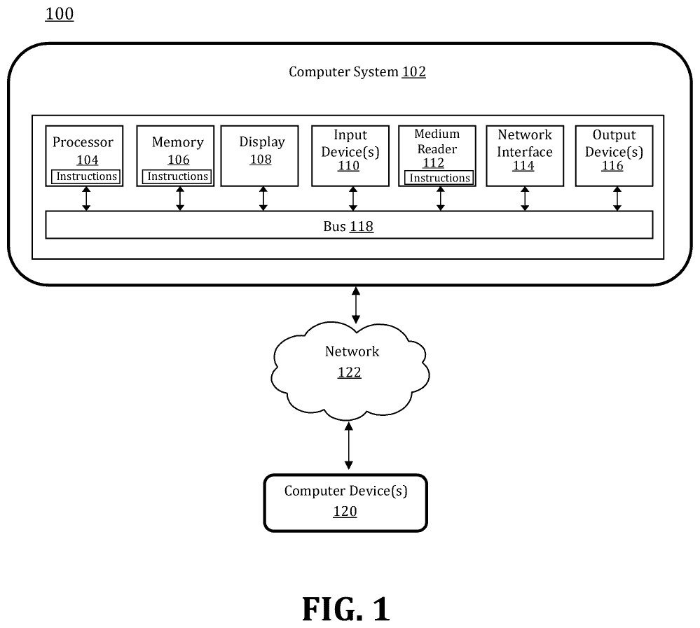

FIG. 1 is a system 100 for efficiently analyzing code to provide suggestions for peer reviewers when reviewing the code, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated peer review module implemented by the system 100 may allow for efficiently analyzing code to provide suggestions for peer reviewers when reviewing the code. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

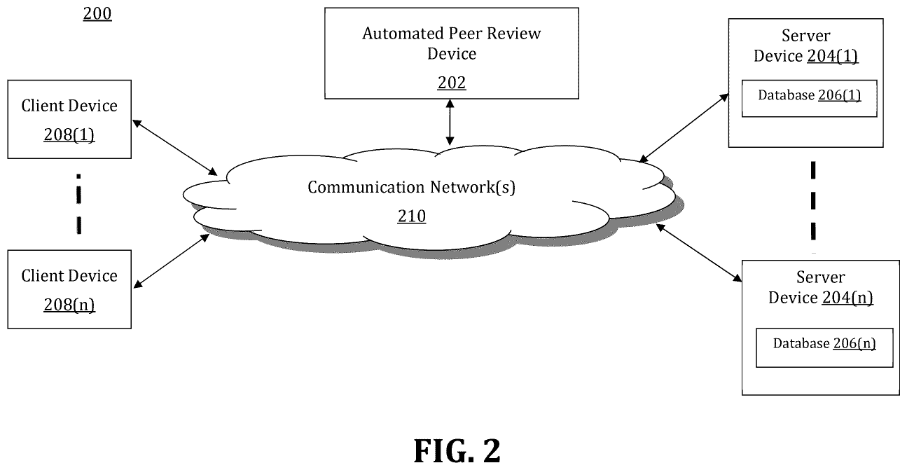

Referring to FIG. 2, a schematic of a network environment 200 for efficiently analyzing code to provide suggestions for peer reviewers when reviewing the code of the instant disclosure is illustrated.

In some embodiments, the above-described problems associated with conventional tools may be overcome by implementing an automated peer review device 202 as illustrated in FIG. 2 that may be configured for efficiently analyzing code to provide suggestions for peer reviewers when reviewing the code, but the disclosure is not limited thereto.

The automated peer review device 202 may include one or more computer systems 102, as described with respect to FIG. 1, which in aggregate provide the necessary functions.

The automated peer review device 202 may store one or more applications that can include executable instructions that, when executed by the automated peer review device 202, cause the automated peer review device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the automated peer review device 202 itself, may be located in virtual server(s) running in a cloud-based computing environment rather than being tied to one or more specific physical network computing devices. Also, the application(s) may be running in one or more virtual machines (VMs) executing on the automated peer review device 202. Additionally, in one or more embodiments of this technology, virtual machine(s) running on the automated peer review device 202 may be managed or supervised by a hypervisor.

In the network environment 200 of FIG. 2, the automated peer review device 202 may be coupled to a plurality of server devices 204(1)-204(n) that hosts a plurality of databases 206(1)-206(n), and also to a plurality of client devices 208(1)-208(n) via communication network(s) 210. A communication interface of the automated peer review device 202, such as the network interface 114 of the computer system 102 of FIG. 1, operatively couples and communicates between the automated peer review device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the automated peer review device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The automated peer review device 202 may be a standalone device or integrated with one or more other devices or apparatuses, such as one or more of the server devices 204(1)-204(n), for example. In one example, the automated peer review device 202 may be hosted by one of the server devices 204(1)-204(n), and other arrangements are also possible. Moreover, one or more of the devices of the automated peer review device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the automated peer review device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the automated peer review device 202 that may efficiently provide a platform for efficiently analyzing code to provide suggestions for peer reviewers when reviewing the code, but the disclosure is not limited thereto.

The client devices 208(1)-208(n) may run interface applications, such as standard web browsers or standalone client applications, which may provide an interface to communicate with the automated peer review device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the automated peer review device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the automated peer review device 202, the server devices 204(1)-204(n), or the client devices 208(1)-208(n), for example, may be configured to operate as virtual instances on the same physical machine. For example, one or more of the automated peer review devices 202, the server devices 204(1)-204(n), or the client devices 208(1)-208(n) may operate on the same physical device rather than as separate devices communicating through communication network(s) 210. Additionally, there may be more or fewer automated peer review devices 202, server devices 204(1)-204(n), or client devices 208(1)-208(n) than illustrated in FIG. 2. In some embodiments, the automated peer review device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

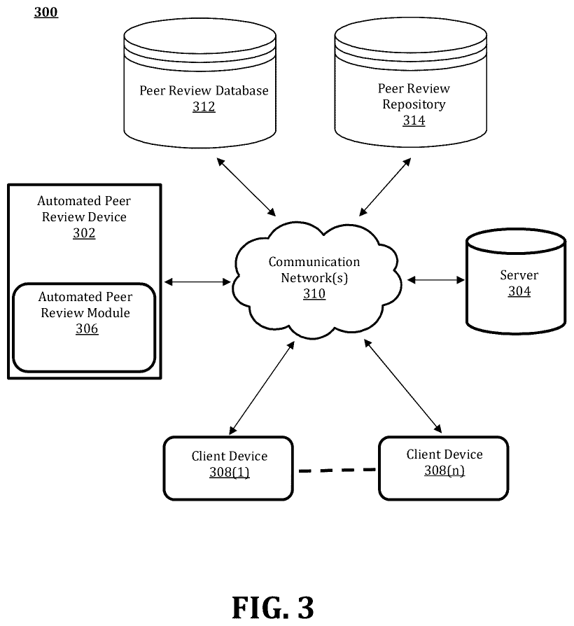

FIG. 3 illustrates a system diagram for efficiently analyzing code to provide suggestions for peer reviewers when reviewing the code in accordance with an embodiment.

As illustrated in FIG. 3, the system 300 may include an automated peer review device 302 within which an automated peer review module 306 is embedded, a server 304, a peer review database 312, a peer review repository 314, a plurality of client devices 308(1). 308(n), and a communication network 310.

In some embodiments, the automated peer review device 302 including the automated peer review module 306 may be connected to the server 304, and the database(s) 312 via the communication network 310. The automated peer review device 302 may also be connected to the plurality of client devices 308(1) . . . 308(n) via the communication network 310, but the disclosure is not limited thereto. The peer review database 312 and the peer review repository 314 may include one or more repositories or databases.

In an embodiment, the automated peer review device 302 is described and shown in FIG. 3 as including the automated peer review module 306, although it may include other rules, policies, modules, databases, or applications, for example. In some embodiments, the peer review database 312 and the peer review repository 314 may be configured to store ready to use modules written for each Application Programming Interface (API) for all environments. Although only one database and one repository are illustrated in FIG. 3, the disclosure is not limited thereto. Any number of desired databases and/or repositories may be utilized for use in the disclosed invention herein. The peer review database 312 and the peer review repository 314 may be a mainframe database, a log database that may produce programming for searching, monitoring, and analyzing machine-generated data via a web interface, but the disclosure is not limited thereto. In addition, the peer review database 312 and the peer review repository 314 may store a plurality of data sets and predictive models for automated peer review.

In some embodiments, the automated peer review module 306 may be configured to receive real-time feed of data from the plurality of client devices 308(1) . . . 308(n) and secondary sources via the communication network 310.

The plurality of client devices 308(1) . . . 308(n) are illustrated as being in communication with the automated peer review device 302. In this regard, the plurality of client devices 308(1) . . . 308(n) may be “clients” (e.g., customers) of the automated peer review device 302 and are described herein as such. Nevertheless, it is to be known and understood that the plurality of client devices 308(1) . . . 308(n) need not necessarily be “clients” of the automated peer review device 302, or any entity described in association therewith herein. Any additional or alternative relationship may exist between either or both plurality of client devices 308(1) . . . 308(n) and the automated peer review device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the automated peer review device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The automated peer review device 302 may be the same or similar to the automated peer review device 202 as described with respect to FIG. 2, including any features or combination of features described with respect thereto.

Upon being started, the automated peer review device 302 executes a process for efficiently analyzing code to provide suggestions for peer reviewers when reviewing the code.

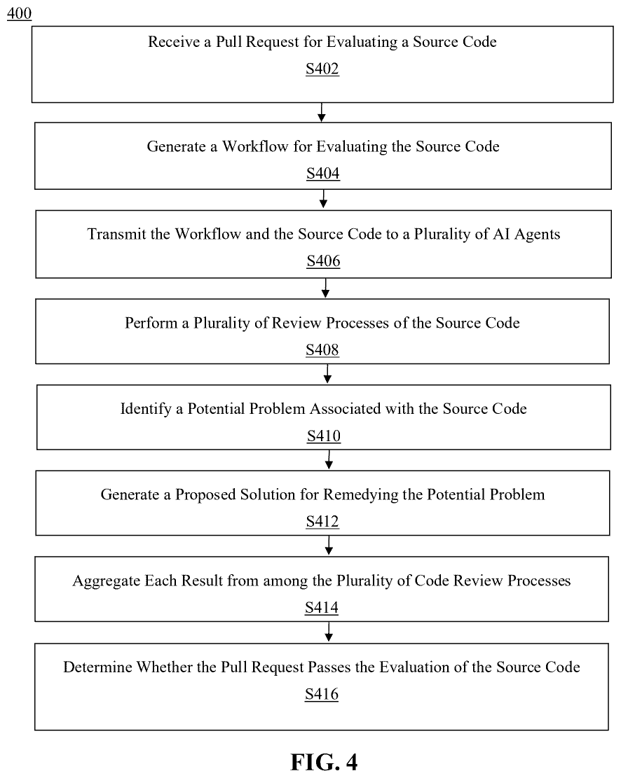

In process 400 of FIG. 4, at step S402, the automated peer review device 302 may be configured to receive a pull request associated with an evaluation of a source code. For example, once a source code is ready to be reviewed, the pull request may be submitted within an internal or third-party platform, so that at least one peer, coworker, or supervisor may review and test the source code prior to its publishing or implementation. The source code may be written in a plurality of different coding languages (e.g., Java).

At step S404, the automated peer review device 302 may be configured to generate a workflow for evaluating the source code. The workflow may be a series of steps or instructions for evaluating the source code. For example, in an embodiment, the workflow may be code generated via a developer platform (e.g., GitHub) for coordinating and instructing the performance of a series of tests and review processes. In an embodiment, the workflow code may be configured to coordinate and provide instruction to a plurality of AI agents. In some embodiments, the workflow may be triggered, generated, and coordinated by the developer platform when the pull request is made. For example, when a developer raises a pull request in a repository, the developer platform workflow may automatically be triggered. The workflow may then initiate the execution of all the AI agents in parallel, ensuring a comprehensive analysis of proposed code changes.

At step S406, the automated peer review device 302 may be configured to transmit the workflow and the source code to the plurality of AI agents. Then, at step S408, the automated peer review device 302 may be configured to perform a review of the source code by coordinating the plurality of AI agents, based on the workflow. In an embodiment, each respective AI agent of the plurality of AI agents may be responsible for a separate code review process from among a plurality of code review processes. The plurality of code review processes may include at least one from among validating a pipeline configuration, testing an individual module of the source code, testing a contract of the source code, testing a component of the source code, testing acceptance of the source code, testing end-to-end results of the source code, testing a performance of the source code, testing resiliency of the source code, providing code review feedback of the source code, testing a compatibility of the source code, testing security vulnerabilities of the source code, and testing business functionality of the source code. In an embodiment, each of the plurality of code review processes may be executed in parallel among the plurality of AI agents. The parallel execution of AI agents may allow for efficient processing, reducing the overall time required for the code review process. Each agent may perform its task independently, leveraging the integrations with various tools to gather and analyze data.

In some embodiments, the automated peer review device 302 may be configured to use an LLM to coordinate each of the plurality of AI agents. The LLM may be used to provide context-aware processing for performing each of the review processes. In some embodiments, the LLM may be trained on at least one source code framework and/or an engineer handbook. The LLM may be trained to understand and generate responses in the context of software development. In an embodiment, the automated peer review device 302 may be configured to integrate at least one source code analysis tool (e.g., Jules, Jira, Jira Align, SonarQube, National Vulnerability Database (NVD), and BlazeMeter) to test the source code during and/or after the review processes for validating the evaluation of the source code.

In some embodiments, the automated peer review device 302 may be configured to automate peer code reviews using a combination of Large Language Models (LLMs), AI agents, and developer platform workflows (e.g., GitHub). The automated peer review device 302 may be integrated with a plurality (e.g., 12) specialized AI agents, each responsible for a distinct task, all integrated into a developer platform workflow. The automated peer review device 302 may be configured to enhance code quality, streamline the review process, and ensure comprehensive testing and validation of code changes. The LLM may be trained to understand and generate code, documentation, and responses related to specific source code frameworks and engineering principles. It may have a deep knowledge in the syntax, semantics, and usage of the source code frameworks, enabling it to provide valuable insights, code snippets, debugging help, and more. For example, if a code developer is working with a high-performance server engine (e.g., Photon), and he/she runs into a complex issue, the LLM may provide potential solutions or alternative methods based on its training. Additionally, the LLM may assist in creating or understanding code specific to other source code frameworks (e.g., Octogon and Pyneta). When it comes to documentation, an LLM trained on an engineer's handbook may be knowledgeable in best practices for creating, maintaining, and interpreting technical documentation. It may provide explanations of complex engineering concepts, help generate technical documentation, and assist in understanding existing documents. The automated peer review device 302 utilizing the LLM may help increase productivity and efficiency, while also assisting in training and learning new concepts related to specific code frameworks and engineering practices.

At step S410, the automated peer review device 302 may be configured to identify potential problems associated with the source code. For example, the automated peer review device 302 may be configured to determine if the source code produces an error or the intended function is not performed when the code is run. In some embodiments, the automated peer review device 302 may be configured to use the LLM to identify the potential problems. The identifying of potential problems may be based on the LLM's understanding of the source code framework and the engineering principles learned during the training.

At step S412, the automated peer review device 302 may be configured to generate a proposed solution for remedying the identified potential problems. For example, the automated peer review device 302 may be configured to generate and recommend potential edits or modifications to the source code to resolve the identified issues. In some embodiments, the automated peer review device 302 may be configured to use the LLM to generate the proposed source code solution, based on the source code framework and the engineer handbook. In an embodiment, the automated peer review device 302 may be configured to generate an explanation that relates to an understanding of the source code framework and engineering concept associated with the source code to be used by the reviewer for understanding the context of the proposed solutions.

At step S414, the automated peer review device 302 may be configured to aggregate each respective result from among the plurality of code review processes. In other words, the automated peer review device 302 may collect the results from all the review processes to generate a single combined result. The result may relate to the source code's overall performance as based on the plurality of review processes. For example, once the AI agents complete their tasks, the results may be sent back to a developer platform workflow. The workflow may aggregate these results, providing a comprehensive view of the code's quality and compliance with various standards and requirements.

Then, at step S416, the automated peer review device 302 may be configured to determine whether the pull request passes the evaluation of the source code. For example, if the source code passes through each of the plurality of review processes without any identifiable errors, the automated peer review device 302 may determine that the source code is compliant and the pull request passes. In some embodiments, the automated peer review device 302 may be configured to generate a report that includes the determination of whether the pull request passes the evaluation, an assessment of each respective result from among the plurality of code review processes, and an assessment of compliance of the source code with a predetermined standard. For example, the report may list the result from each review processes and any identifiable errors or issues that occurred in the source code. The report may be transmitted to a user, for example the peer reviewers, so that they can review the report for their own assessment associated with the pull request. In an embodiment, based on the aggregated results, a developer platform workflow may determine whether the pull request passes or fails. The decision criteria may be defined based on the organization's standards and can be customized as needed. The final status is communicated back to the developer of the source code or the peer reviewer, along with detailed feedback from each AI agent.

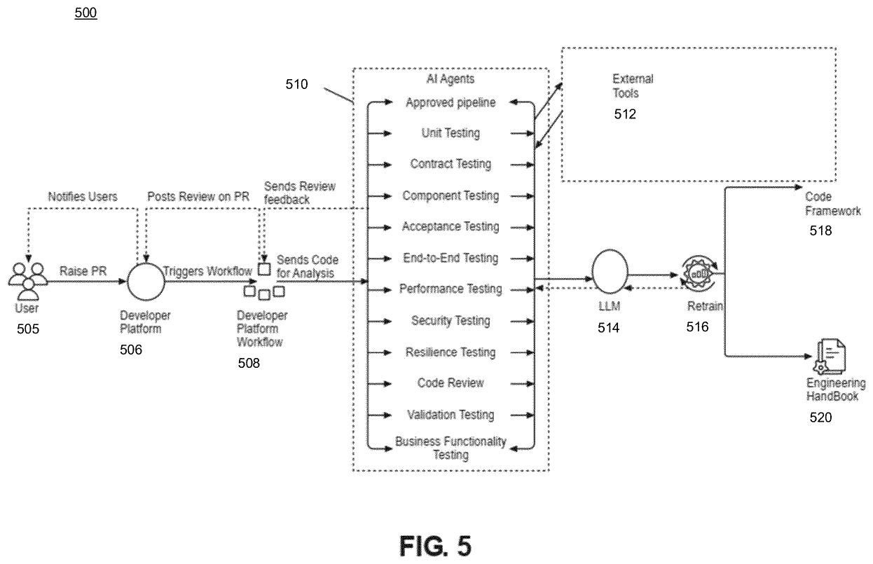

FIG. 5 illustrates a system architectural diagram 500 for efficiently analyzing code to provide suggestions for peer reviewers when reviewing the code, according to an embodiment. The system architectural diagram 500 illustrates a general architectural diagram of the process 400 of FIG. 4, according to an embodiment, and includes a user 505, a developer platform 506, a developer platform workflow module 508, a series of AI agents 510, external tools 512, an LLM 514, a retrain module 516, a code framework 518, and an engineering handbook 520.

Particularly, as illustrated by the system architectural diagram 500, a user 505 raises a pull request (PR) for a source code that may be transmitted to a developer platform 506 (e.g., GitHub). The developer platform 506 may then trigger a workflow to be developed at a developer platform workflow module 508 (e.g., GitHub workflow). The source code and the workflow may then be transmitted to a series of AI agents 510 that may each perform a separate review process on the source code and may be orchestrated by the workflow. During the review process, the AI agents 510 may be integrated with various external tools 512 (e.g., Jules, Jira, Jira Align, SonarQube, NVD, and BlazeMeter) for various testing and validation tasks. The AI agents may also be integrated with an LLM 514 that receives data associated with the review processes from the AI agents 510. Once the LLM 514 receives the data it goes through a retraining 516 using the received review process data, as well as data from a source code framework 518 and an engineering handbook 520. The information learned from the LLM 514 during the retraining 516 may then be transmitted to and used by the AI agents 510 for the review process and for generating suggested corrections to fix potential issues with the source code. Upon completion of the review process, the feedback from the review may be transmitted back to the developer platform workflow module 508. The review may then be posted on the PR at the developer platform 506 and the user may then be notified.

The automated peer review device 302 may provide an approach to automating peer code reviews using AI agents connected to an LLM and integrated with tools (e.g., Jenkins (referred to as Jules), Jira, Jira Align, SonarQube, the NVD, and BlazeMeter). These AI agents work in parallel when a PR is raised, performing various tests and checks to ensure the code's quality and compliance.

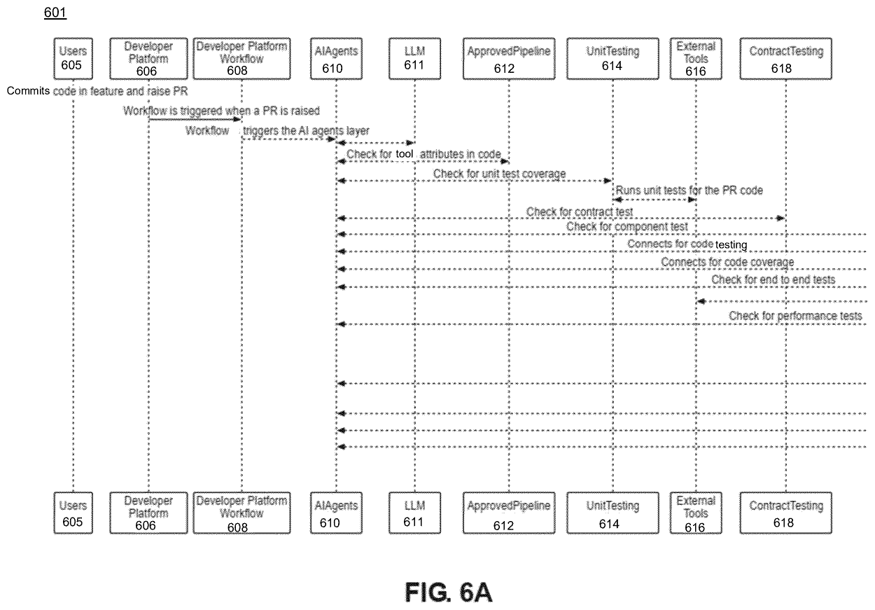

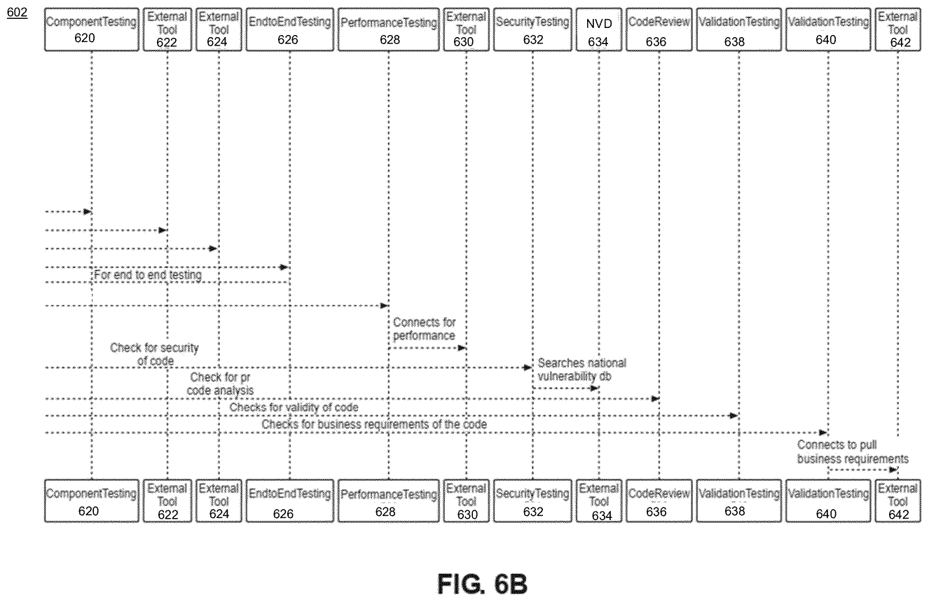

Regarding the system architectural diagram 500, the LLM 514 may be integrated to act as a central intelligence, coordinating the AI agents and providing context-aware processing. In an embodiment, the AI Agents 510 may include a set of 12 AI agents, each responsible for a specific aspect of the code review process. The developer platform workflow module 508 may orchestrate the execution of the AI agents 510 upon the creation of a PR. External tools 512 may include various tools (e.g., Jenkins (Jules), Jira, Jira Align, SonarQube, NVD, and BlazeMeter) that are integrated for various testing and validation tasks, as further illustrated and described in FIG. 6A and FIG. 6B. The LLM 514 may be trained on various code frameworks (e.g., Photon, Octogon, Pyneta, and an engineer handbook) in order to understand, interpret, and respond in a context specific to software development and engineering.

The system architectural diagram 500 illustrates 12 AI Agents 510. For example, one of the AI agents may include an Approved Pipeline Agent that checks for attributes of the external tools 512 (e.g., Jules) in the PR code. The Approved Pipeline Agent may be integrated via the external tools 512 (e.g., Jenkins (Jules)) and may output a validation of pipeline configurations. Another AI agent may include a Unit Testing Agent that connects to the external tools 512 (e.g., Jules) to run unit tests on the PR diff code. The Unit Testing Agent may be integrated via the external tools 512 (e.g., Jenkins (Jules)) and may output unit test results. Another AI agent may include a Contract Testing Agent that performs a software security scan (e.g., software security assurance program (SSAP) scan). The Contract Testing Agent may be integrated via the external tools 512 (e.g., SSAP) and may output contract test results. Another AI agent may include a Component Testing Agent that connects to the external tools 512 (e.g., SonarQube) and performs code coverage analysis. The Component Testing Agent may be integrated via the external tools 512 (e.g., SonarQube) and may output a code coverage report. Another AI agent may include an Acceptance Testing Agent that performs acceptance testing. The Acceptance Testing Agent may be integrated via internal testing frameworks and may output acceptance test results. Another AI agent may include an End-to-End Testing Agent that conducts full system testing. The End-to-End Testing Agent may be integrated via internal testing frameworks and may output end-to-end test results. Another AI agent may include a Performance Testing Agent that connects to the external tools 512 (e.g., BlazeMeter) and runs performance tests on the diff code. The Performance Testing Agent may be integrated via the external tools 512 (e.g., BlazeMeter) and may output performance test results. Another AI agent may include a Resiliency Testing Agent that checks the code's resiliency. The Resiliency Testing Agent may be integrated via internal resiliency testing tools and may output resiliency test results. Another AI agent may include a Code Review Agent that performs peer code analysis of the PR diff code. The Code Review Agent may be integrated via an LLM for advanced analysis and may output code review feedback. Another AI agent may include a Validation Testing Agent that checks the version compatibility of the code. The Validation Testing Agent may be integrated via internal compatibility tools and may output compatibility test results. Another AI agent may include a Security Testing Agent that connects to the NVD to search for vulnerabilities in the PR code. The Security Testing Agent may be integrated via the NVD and may output a security vulnerabilities report. Another AI agent may include a Business Functionality Testing Agent that connects to the external tools 512 (e.g., Jira and Jira Align) to ensure the PR code aligns with business requirements. The Business Functionality Testing Agent may be integrated via the external tools 512 (e.g., Jira and Jira Align) and may output a business requirements compliance report.

FIG. 6A illustrates a flow diagram 601 for efficiently analyzing code to provide suggestions for peer reviewers when reviewing the code, according to an embodiment. FIG. 6B illustrates a flow diagram 602 that is a continuation of the flow diagram 601 for efficiently analyzing code to provide suggestions for peer reviewers when reviewing the code, according to an embodiment. The flow diagrams 601 and 602 illustrate the interconnection and communication between each of the components for the process 400 of FIG. 4, according to an embodiment.

Particularly, as illustrated by the system architectural diagrams 601 and 602, a user 605 generates a source code and raises a PR at a developer platform 606 (e.g., GitHub). Once the PR is raised, a workflow may be triggered at the developer platform workflow module 608. The developer platform workflow module 608 may then trigger a layer or series of AI agents 610. The AI agents 610 may be in communication with the LLM 611 and may also check for tool (e.g., Jules) attributes in the source code at the approved pipeline 612. Additionally, the AI agents 610 may check for unit test coverage at the unit testing module 614. The unit testing module 614 may run test for the source code at an external tool (e.g., Jules) module 616. Furthermore, the AI agents 610 may check for contract tests at the contract testing module 618 and may also check for component tests at the component testing module 620. Moreover, the AI agents 610 may connect to an external tool (e.g., SSAP) module 622 for code testing and may also check for end-to-end tests at another external tool (e.g., SonarQube) module 624. The external tool (e.g., Jules) module 616 may perform end to end testing at an end-to-end testing module 626. Additionally, the AI agents 610 may check for performance tests at a performance testing module 628. The performance testing module 628 may also connect to an external tool (e.g., BlazeMeter) for evaluating performance. The AI agents 610 may check or assess the security of the source code at a security testing module 632. The security testing module 632 may search an NVD 634 for assessing the security of the source code. The AI agents 610 may analyze the source code at a code review module 636 and may also check for the validity of the source code at a code review module 636. The AI agents 610 may also check for business requirements of the code at a validation testing module 640. The validation testing module 640 may connect to an external tool (e.g., Jira) module 642 to pull business requirements.

The system architectural diagrams 601 and 602 illustrate four workflows. One of the workflows may include a PR Creation workflow, in which a developer raises a PR, triggering the developer platform workflow. A second one of the workflows may include an AI Agents Execution workflow that concurrently runs a plurality of AI agents, each performing its designated task. Another one of the workflows may include a Results Aggregation workflow, where each agent sends its results back to the workflow. The fourth one of the workflows may include a Final Decision workflow that aggregates the results and determines whether the PR passes or fails based on predefined criteria.

Accordingly, with this technology, an optimized process for efficiently analyzing code to provide suggestions for peer reviewers when reviewing the code is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for automating a peer code review, the method being implemented by at least one processor, the method comprising:
receiving, by the at least one processor, a pull request associated with an evaluation of a source code;
generating, by the at least one processor and based on the pull request, a workflow associated with the evaluation of the source code;
transmitting, by the at least one processor, the workflow and the source code to a plurality of AI agents;
performing, by the at least one processor via the plurality of AI agents, a review of the source code, wherein each respective AI agent of the plurality of AI agents is responsible for a separate code review process from among a plurality of code review processes;
aggregating, by the at least one processor, each respective result from among the plurality of code review processes; and
determining, by the at least one processor and based on the aggregating of each respective result, whether the pull request passes the evaluation of the source code.

2. The method of claim 1, further comprising:
coordinating, by the at least one processor via a Large Language Model (LLM), each of the plurality of the AI agents and providing context-aware processing for the performing of the review, wherein the LLM is trained on at least one from among a code framework and an engineer handbook in order to understand and generate responses in a context associated with a software development.

3. The method of claim 2, further comprising:
identifying, by the at least one processor via the LLM, at least one potential problem associated with the source code; and
generating, by the at least one processor via the LLM, at least one proposed source code solution, based on the at least one from among the code framework and the engineer handbook, for remedying the at least one identified potential problem.

4. The method of claim 2, further comprising:
generating, by the at least one processor via the LLM, at least one from among a first explanation that relates to an understanding of the code framework and a second explanation that relates to at least one engineering concept associated with the source code.

5. The method of claim 1, wherein the plurality of code review processes includes at least one from among validating a pipeline configuration, testing an individual module of the source code, testing a contract of the source code, testing a component of the source code, testing acceptance of the source code, testing end-to-end results of the source code, testing a performance of the source code, testing resiliency of the source code, providing code review feedback of the source code, testing a compatibility of the source code, testing security vulnerabilities of the source code, and testing business functionality of the source code.

6. The method of claim 1, further comprising:
triggering, by the at least one processor via a developer platform, the generating of the workflow; and
coordinating, by the at least one processor via the developer platform, the performing of the review by the plurality of AI agents.

7. The method of claim 1, further comprising:
integrating, by the at least one processor, at least one source code analysis tool for testing the source code and for validating the evaluation of the source code.

8. The method of claim 1, wherein each of the plurality of code review processes is executed in parallel among the plurality of AI agents.

9. The method of claim 1, further comprising:
generating, by the at least one processor, a report that includes the determination of whether the pull request passes the evaluation, an assessment of each respective result from among the plurality of code review processes, and an assessment of compliance of the source code with a predetermined standard; and
transmitting, by the at least one processor, the report to a user associated with the pull request.

10. A computing apparatus for automating peer code reviews, the computing apparatus comprising:
a processor;
a memory; and
a communication interface coupled to each of the processor and the memory,
wherein the processor is configured to:
receive a pull request associated with an evaluation of a source code;
generate, based on the pull request, a workflow associated with the evaluation of the source code;
transmit the workflow and the source code to a plurality of AI agents;
perform, via the plurality of AI agents, a review of the source code, wherein each respective AI agent of the plurality of AI agents is responsible for a separate code review process from among a plurality code review processes;
aggregate each respective result from among the plurality of code review processes; and
determine, based on the aggregating of each respective result, whether the pull request passes the evaluation of the source code.

11. The computing apparatus of claim 10, wherein the processor is further configured to:
coordinate, via a Large Language Model (LLM), each of the plurality of the AI agents and providing context aware processing for the performing of the review, wherein the LLM is trained on at least one from among a code framework and an engineer handbook in order to understand and generate responses in a context associated with a software development.

12. The computing apparatus of claim 11, wherein the processor is further configured to:
identify, via the LLM, at least one potential problem associated with the source code; and
generate, via the LLM, at least one proposed source code solution, based on the at least one from among the code framework and the engineer handbook, for remedying the at least one identified potential problem.

13. The computing apparatus of claim 11, wherein the processor is further configured to:
generate, via the LLM, at least one from among a first explanation that relates to an understanding of the code framework and a second explanation that relates to at least one engineering concept associated with the source code.

14. The computing apparatus of claim 10, wherein the plurality of code review processes includes at least one from among validating a pipeline configuration, testing an individual module of the source code, testing a contract of the source code, testing a component of the source code, testing acceptance of the source code, testing end-to-end results of the source code, testing a performance of the source code, testing resiliency of the source code, providing code review feedback of the source code, testing a compatibility of the source code, testing security vulnerabilities of the source code, and testing business functionality of the source code.

15. The computing apparatus of claim 10, wherein the processor is further configured to:
trigger, via a developer platform, the generation of the workflow; and
coordinate, via the developer platform, the performance of the review by the plurality of AI agents.

16. The computing apparatus of claim 10, wherein the processor is further configured to:
integrate at least one source code analysis tool for testing the source code and to validate the evaluation of the source code.

17. The computing apparatus of claim 10, wherein each of the plurality of code review processes is executed in parallel among the plurality of AI agents.

18. The computing apparatus of claim 10, wherein the processor is further configured to:
generate a report that includes the determination of whether the pull request passes the evaluation, an assessment of each respective result from among the plurality of code review processes, and an assessment of compliance of the source code with a predetermined standard; and
transmit the report to a user associated with the pull request.

19. A non-transitory computer readable storage medium storing instructions for automating peer code reviews, the storage medium comprising executable code which, when executed by a processor, causes the processor to:
receive a pull request associated with an evaluation of a source code;
generate, based on the pull request, a workflow associated with the evaluation of the source code;
transmit the workflow and the source code to a plurality of AI agents;
perform, via the plurality of AI agents, a review of the source code, wherein each respective AI agent of the plurality of AI agents is responsible for a separate code review process from among a plurality code review processes;
aggregate each respective result from among the plurality of code review processes; and
determine, based on the aggregating of each respective result, whether the pull request passes the evaluation of the source code.

20. The storage medium of claim 19, wherein when executed by the processor, the executable code further causes the processor to:
coordinate, via a Large Language Model (LLM), each of the plurality of the AI agents and providing context aware processing for the performing of the review, wherein the LLM is trained on at least one from among a code framework and an engineer handbook in order to understand and generate responses in a context associated with a software development.
